(19) United States
(12) Patent Application Publication
(10) Pub. No.: US 2012/0181363 A1
(43) Pub. Date: Jul. 19, 2012

(54) COOKING UTENSIL

(76) Inventor: J. Y. HUANG, Tainan City (TW)

(21) Appl. No.: 13/008,779

(22) Filed: Jan. 18, 2011

(51) Int. Cl. B02C 23/00; B02C 19/00

(52) U.S. Cl. 241/65; 241/277; 241/100

(57) ABSTRACT

A cooking utensil includes a cooking bowl unit, a driving support unit, a lid unit, and a lid-opening device. The driving support unit outputs a power to the cooking bowl unit, and includes a bottom seat supporting the cooking bowl unit, and opposite first and second sidewalls disposed on the bottom seat . The lid unit includes a top lid disposed pivotally on a bowl body of the cooking bowl unit for covering a top end opening of the blow body, a pivoting block disposed fixedly on the top lid, a positioning block connected pivotally to the pivoting block and connected removably to the first sidewall, and a retaining block disposed on the top lid. The lid-opening device is disposed on the second sidewall, and includes a locking member locking the retaining block releaseably on the second sidewall, and a controlling member operable to release the retaining block from the second sidewall.

### BACKGROUND OF THE INVENTION

1. Field of the Invention

This invention relates to a cooking utensil, and more particularly to a cooking utensil including a top lid that can be opened in a safety manner.

2. Description of the Related Art

Typically, a food product is taken out of a conventional cooking utensil by removing or pivoting a top lid.

An incorrect lid-opening operation may cause damage to an user. For example, during cooking, the user touches the top lid with one hand in such a manner that no thermal insulation is disposed between the top lid and the hand. In this case, if the top lid has a relatively high temperature, or if steam escapes from the cooking utensil, it will scald the user. To solve this problem, it is desirable that a top lid of a cooking utensil can be opened without any contact between the hand of the user and the top lid, so as to enhance safety during use.

### SUMMARY OF THE INVENTION

The object of this invention is to provide a cooking utensil that includes a top lid openable without any contact between one hand of a user and the top lid.

Accordingly, a cooking utensil of this invention includes a cooking bowl unit, a driving support unit, a lid unit, and a lid-opening device. The driving support unit outputs a power to the cooking bowl unit, and includes a bottom seat supporting the cooking bowl unit, and opposite first and second sidewalls disposed on the bottom seat. The lid unit includes a top lid disposed pivotally on a bowl body of the cooking bowl unit for covering a top end opening of the blow body, a pivoting block disposed fixedly on the top lid, a positioning block connected pivotally to the pivoting block and connected removably to the first sidewall, and a retaining block disposed on the top lid. The lid-opening device is disposed on the second sidewall, and includes a locking member locking the retaining block releaseably on the second sidewall, and a controlling member operable to release the retaining block from the second sidewall.

As such, when opening of the top lid is desired, it is only necessary to touch and operate the controlling member with one hand. In other words, contact between the hand and the top lid can be avoided, thereby ensuring safety during use.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is an assembled perspective view of the preferred embodiment of a cooking utensil according to this invention;

FIG. 2 is a partly exploded perspective view of a cooking bowl unit of the preferred embodiment;

FIG. 3 is a bottom view of the cooking bowl unit;

FIG. 4 is a fragmentary perspective view of the preferred embodiment, illustrating a lid unit;

FIG. 5 is a fragmentary sectional view of the preferred embodiment, illustrating that the lid unit is in a fully closed position;

FIG. 6 is a fragmentary sectional view of the preferred embodiment, illustrating that the lid unit is in an opened position;

FIG. 7 is a fragmentary sectional view of the preferred embodiment, illustrating removal of the lid unit;

FIG. 8 is a fragmentary schematic top view of the preferred embodiment, illustrating a lid-opening device;

FIG. 9 is a fragmentary sectional view of the preferred embodiment, illustrating that a locking member of the lid-opening device is disposed at a locking position to retain a retaining block of the lid unit thereon to thereby lock the lid unit in the fully closed position;

FIG. 10 is a fragmentary sectional view of the preferred embodiment, illustrating that the locking member is disposed at a release position to release the retaining block therefrom to thereby allow the lid unit to be opened;

FIG. 11 is a fragmentary perspective view of the preferred embodiment, illustrating that a safety device is disposed on a second sidewall;

FIG. 12 is a fragmentary sectional view of the preferred embodiment, illustrating that a pressing block of the lid unit is spaced apart from a pushbutton portion of the safety device; and

FIG. 13 is a fragmentary sectional view of the preferred embodiment, illustrating that the pressing block of the lid unit presses against the pushbutton portion of the safety device.

### DETAILED DESCRIPTION OF THE PREFERRED EMBODIMENT

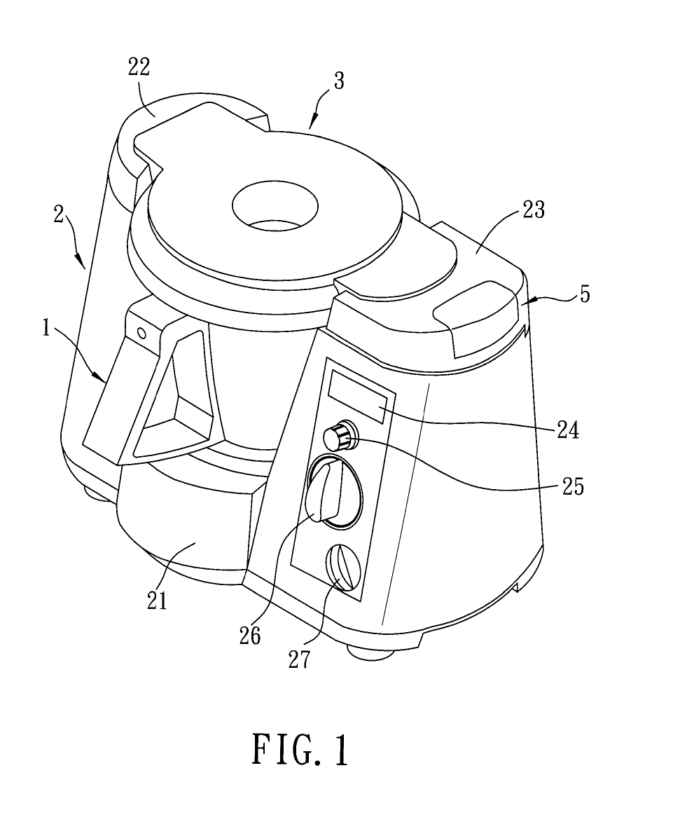

Referring to FIG. 1, the preferred embodiment of a cooking utensil according to this invention includes a cooking cowl unit 1, a driving support unit 2 for outputting a power (such as mechanical power or electrical power) to the cooking bowl unit 1, a lid unit 3 for covering a top end opening of the cooking bowl unit 1, and a lid-opening device 5 disposed on the driving support unit 2.

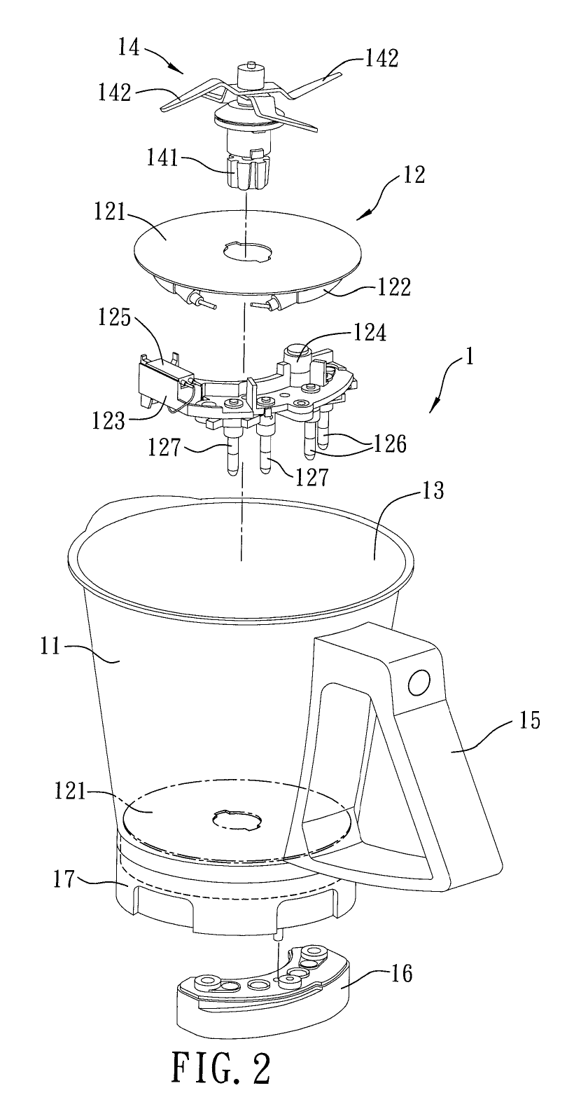

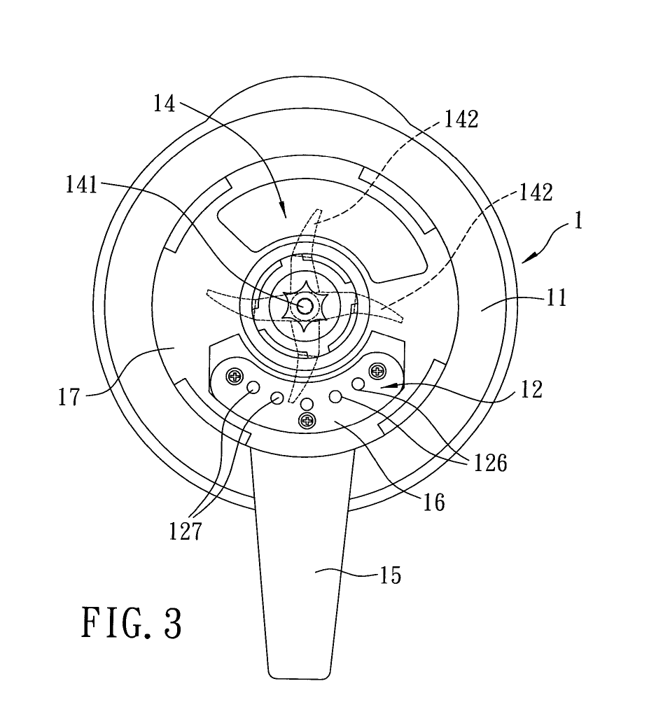

With further reference to FIGS. 2 and 3, the cooking bowl unit 1 includes a unitary bowl body 11 made of stainless steel, an electric heating disk 12 disposed in a bottom end of the bowl body 11 and cooperating with an inner wall surface of the bowl body 11 to define a food receiving space 13 therebetween, a shredding cutter 14 disposed rotatably within a bottom end of the food receiving space 13, and a handle 15 disposed on a front side of the bowl body 11.

The electric heating disk 12 includes: a heating disk body 121 made of stainless steel, defining a bottom end of the food receiving space 13, and having a periphery in sealing contact with the inner wall surface of the bowl body 11; a C-shaped heating pipe 122 disposed on a bottom surface of the heating disk body 121; a curved mounting block 123 disposed on the bottom surface of the heating disk body 121 and disposed within a gap defined by the C-shaped heating pipe 122; a temperature sensor 124 disposed on and above the mounting block 123 and in contact with the bottom surface of the heating disk body 121; a temperature controlling switch 125 disposed on and above the mounting block 123 and in contact with the bottom surface of the heating disk body 121; two sensor-connecting terminals 126 disposed on and under the mounting block 123, spaced apart from each other, and electrically connected to the temperature sensor 124; and two driver-connecting terminals 127 disposed on and under the mounting block 123, spaced apart from each other, and electrically connected to the temperature controlling switch 125. The sensor-connecting terminals 126 and the driver-connecting terminals 127 extend downwardly from the bottom end of the bowl body 11.

The shredding cutter 14 includes a rotating shaft 141 extending downwardly from the bottom end of the bowl body 11 into the driving support unit 2, and a plurality of blades 142 extending radially and outwardly from a top end portion of the rotating shaft 141 and located at the bottom end of the food receiving space 13.

The cooking bowl unit 1 further includes a leakproof block 16 disposed on the bottom surface of the bowl body 11 and permitting extension of the sensor-connecting terminals 126 and the driver-connecting terminals 127 therethrough, and a protective bottom sleeve 17 covering the bottom end of the bowl body 11. In this embodiment, the leakproof block 16 and the protective bottom sleeve 17 are made of rubber.

With particular reference to FIGS. 1, 2, and 4, the driving support unit 2 has a generally U-shaped structure that is open forwardly, rearwardly, and upwardly. The driving support unit 2 is electrically connected to an external power supply (not shown), and includes a bottom seat 21 supporting the cooking bowl unit 1 thereon, first and second sidewalls 22, 23 disposed respectively on left and right sides of the bottom seat 21, a retaining ring 28 disposed fixedly in a recess 221 of the first sidewall 22, a driving motor (not shown) disposed in the bottom seat 21 and connected to the rotating shaft 141 of the shredding cutter 14, a time indicator 24, a time-controlling rotary knob 25, a speed-controlling rotary knob 26, and a rotation-controlling pushbutton 27. In this embodiment, the time indicator 24, the time-controlling rotary knob 25, the speed-controlling rotary knob 26, and the rotation-controlling pushbutton 27 are disposed on a front side surface of the second sidewall 23. The time-controlling rotary knob 25 is disposed under the time indicator 24, and above the speed-controlling rotary knob 26. The rotation-controlling pushbutton 27 is disposed below the speed-controlling rotary knob 26. The driving motor, the time indicator 24, the time-controlling rotary knob 25, the speed-controlling rotary knob 26, and the rotation-controlling pushbutton 27 are electrically connected to a circuit board (not shown) in the second sidewall 23. The sensor-connecting terminals 126 and the driver-connecting terminals 127 of the electric heating disk 12 extend into the bottom seat 21 to electrically connect with the circuit board.

In this embodiment, the speed-controlling rotary knob 26 can be rotated to the right to set the rotational speed of the shredding cutter 14 at a first speed for coarse shredding vegetables, a second speed for manufacturing pasty food products, or a third speed for manufacturing sandy ice. Or, the speed-controlling rotary knob 26 can be rotated to the left to set the food receiving space 13 at a first temperature for temperature conservation, a second temperature for cooking thick soup while stirring, or a third temperature for cooking thick sauce while stirring. It should be noted that, since operation and control of the circuit board, the time indicator 24, the time-controlling rotary knob 25, the speed-controlling rotary knob 26, the rotation-controlling pushbutton 27, the driving motor, the shredding cutter 14, and the electric heating disk 12 are known in the art, further description thereof will be omitted herein for brevity.

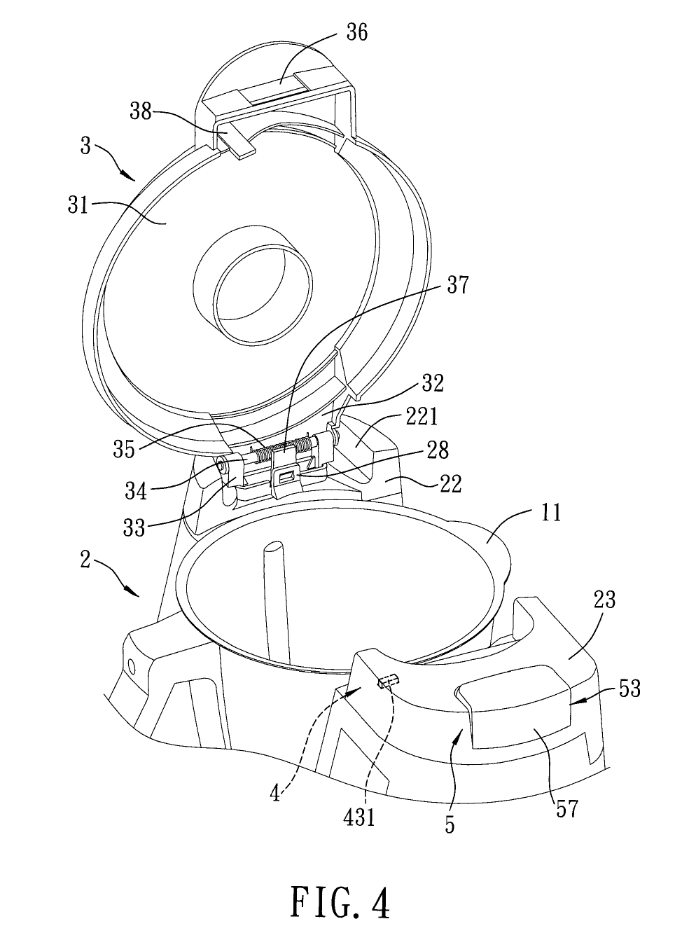

With particular reference to FIGS. 4, 5, and 6, the lid unit 3 includes a top lid 31 disposed pivotally on the bowl body 11 for covering a top end opening of the bowl body 11, a pivoting block 32 disposed fixedly on the top lid 31, a positioning block 33 disposed removably in the recess 221 in the first sidewall 22, a pivot shaft 34 extending through the pivoting block 32 and the positioning block 33 for interconnecting the pivoting block 32 and the positioning block 33 pivotally, a torsion spring 35 sleeved on the pivot shaft 34 for biasing the top lid 31 to pivot upwardly relative to the bowl body 11, a retaining block 36 disposed on a periphery of the top lid 31 and locked releaseably on the second sidewall 23, a resilient retaining tongue 37 extending integrally and upwardly from the positioning block 33 and engaging the retaining ring 28 so as to retain the lid unit 3 on the first sidewall 22, and a pressing block 38 disposed on the retaining block 36 and adjacent to the periphery of the top lid 31. The retaining tongue 37 is pushable to pivot on the positioning block 33 to separate from the retaining ring 28.

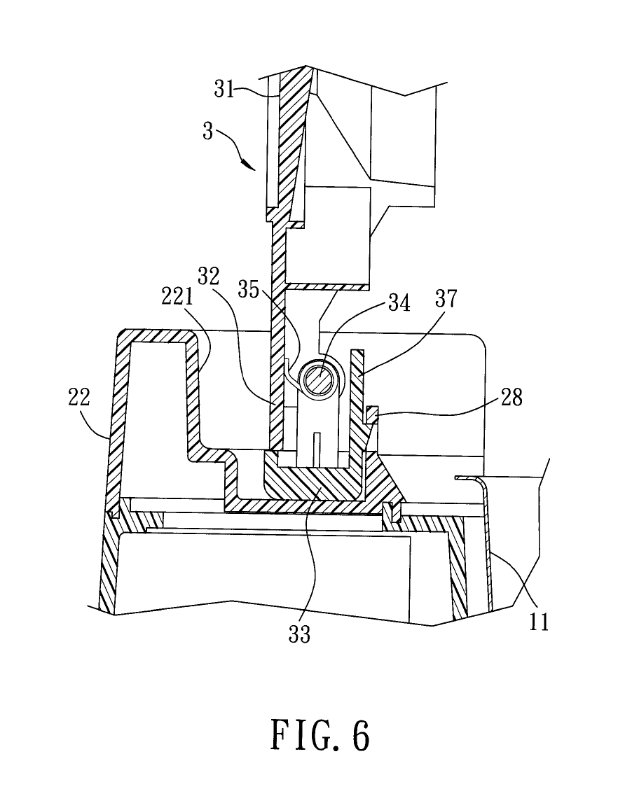

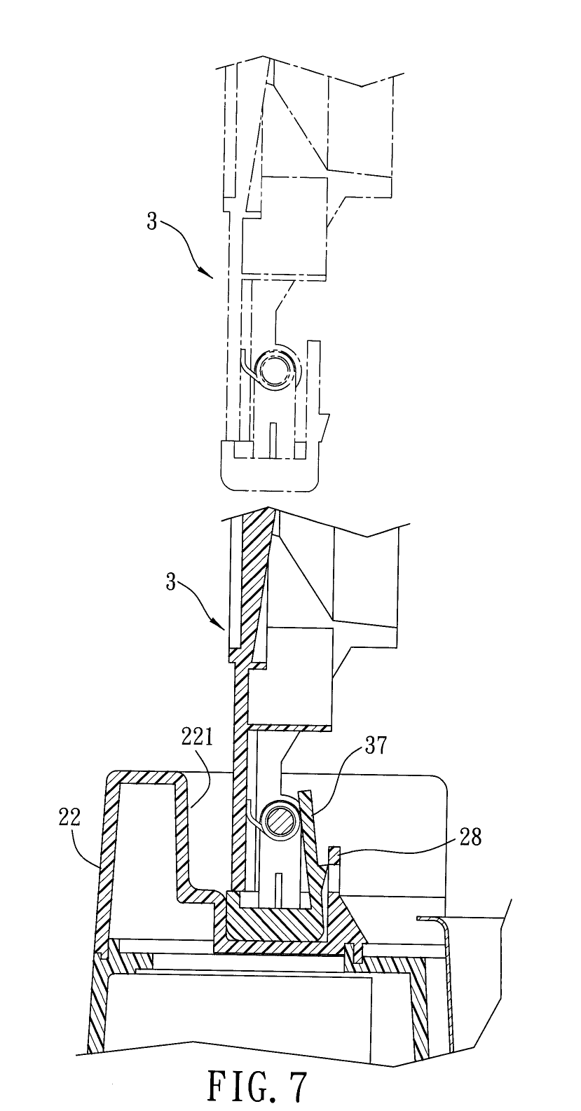

When it is desired to remove the lid unit 3 from the first sidewall 22, it is only necessary to push the retaining tongue 37 from an engagement position shown in FIG. 6 to a disengagement position shown in FIG. 7. In the disengagement position, the retaining tongue 37 is disengaged from the retaining ring 28 to allow for removal of the lid unit 3 from the firs sidewall 22. Subsequently, to reassemble the lid unit 3 to the first sidewall 22, the lid unit 3 is inserted into the recess 221 to thereby engage automatically the retaining tongue 37 with the retaining ring 28.

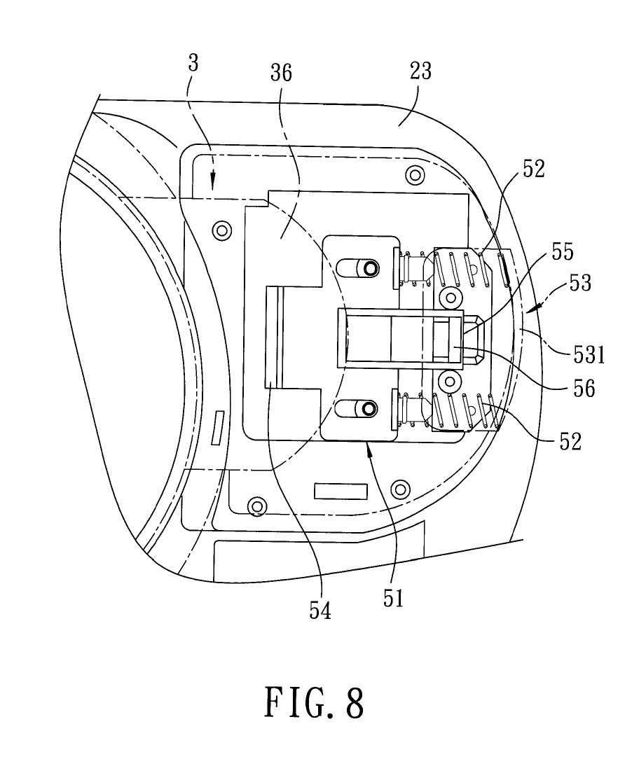

With particular reference to FIGS. 4, 8, and 9, the lid-opening device 5 is disposed on the second sidewall 23, and is operable to open the lid unit 3. The lid opening device 5 includes a locking member 51 configured as a horizontal rod and movable horizontally in the second sidewall 23 for locking the retaining block 36 on the second sidewall 23, a first spring unit consisting of two coiled first compression springs 52 and connected to the locking member 51, and a controlling member 53 movable vertically relative to the second sidewall 23 and operable to remove the locking member 51 from the retaining block 36.

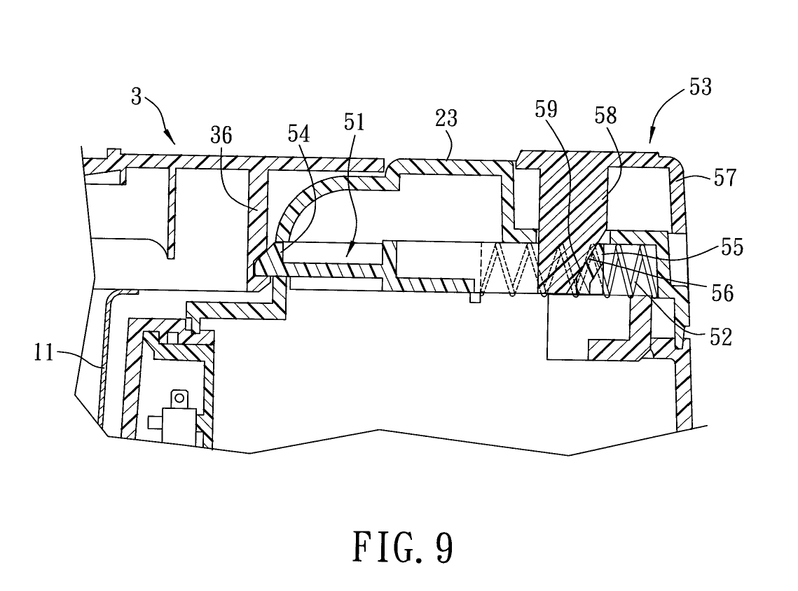

The locking member 51 has a retaining end 54 extendable outwardly from the second sidewall 23 for locking the retaining block 36 releaseably on the second sidewall 23 and retractable into the second sidewall 23, and a driven end 55 opposite to the retaining end 54 and contactable with the controlling member 53. The driven end 55 has an inclined guiding surface 56 that is inclined rightwardly and upwardly, as shown in FIG. 9.

The controlling member 53 has an actuator portion 57 exposed outwardly of the second sidewall 23, and a connecting portion 58 connected to the actuator portion 57 and extending into the second sidewall 23. The connecting portion 58 has an inclined contact surface 59 that is contactable with the inclined guiding surface 56 of the locking member 51 and that is inclined rightwardly and upwardly.

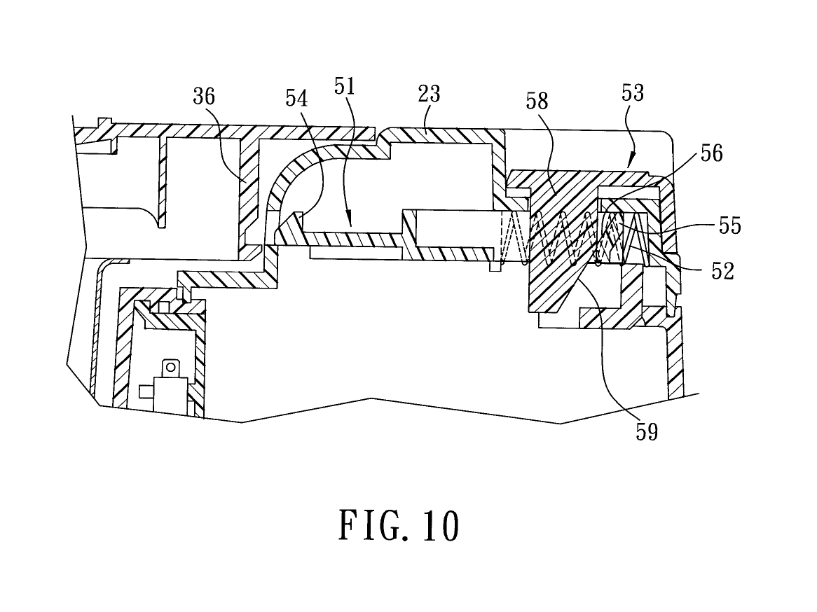

The controlling member 53 cooperates with the first compression springs 52 to move the locking member 51 horizontally on the second sidewall 23 between a locking position shown in FIG. 9 and a release position shown in FIG. 10, so as to control opening and closing of the lid unit 3.

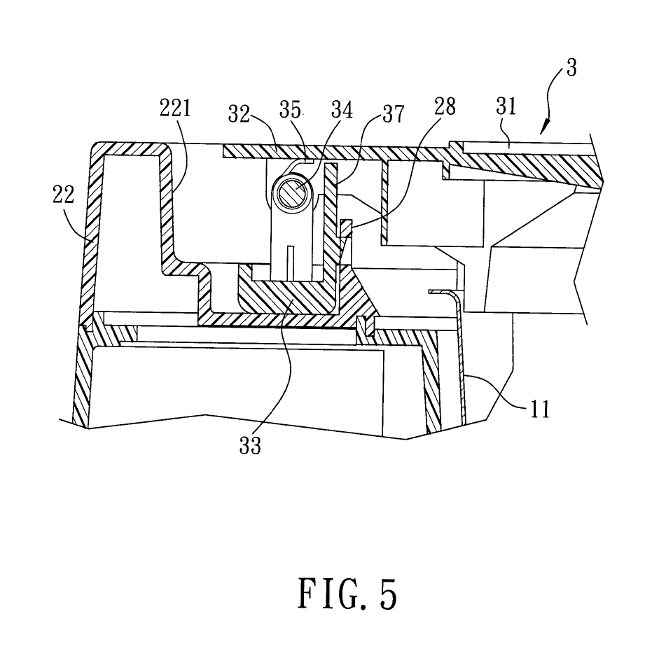

With particular reference to FIGS. 5 and 9, when the lid unit 3 is disposed in a fully closed position, the torsion spring 35 is deformed, and the locking member 51 is at the locking position, such that the retaining end 54 is disposed outwardly of the second sidewall 23 for retaining the retaining block 36 on the second sidewall 23. With particular reference to FIGS. 6 and 10, when the controlling member 53 is depressed, the contact surface 59 of the connecting portion 58 moves downwardly to contact and push the inclined guiding surface 56 to the right. Hence, the retaining end 54 is retracted into the second sidewall 23 to thereby separate from the retaining block 36, so that the locking member 51 is moved to the release position, thus releasing the retaining block 36 from the second sidewall 23 and compressing the first compression springs 52. Upon separation of the retaining end 54 from the retaining block 36, the torsion spring 35 biases the pivoting block 32, the top lid 31, and the retaining block 36 to pivot upwardly to thereby open the lid unit 3. Thereafter, when the controlling member 53 is released, the first compression springs 52 restore their original shapes to move the locking member 51 leftwardly to the locking position. During leftward movement of the locking member 51, the driven end 55 pushes the connecting portion 58 so as to return the controlling member 53 to its original position.

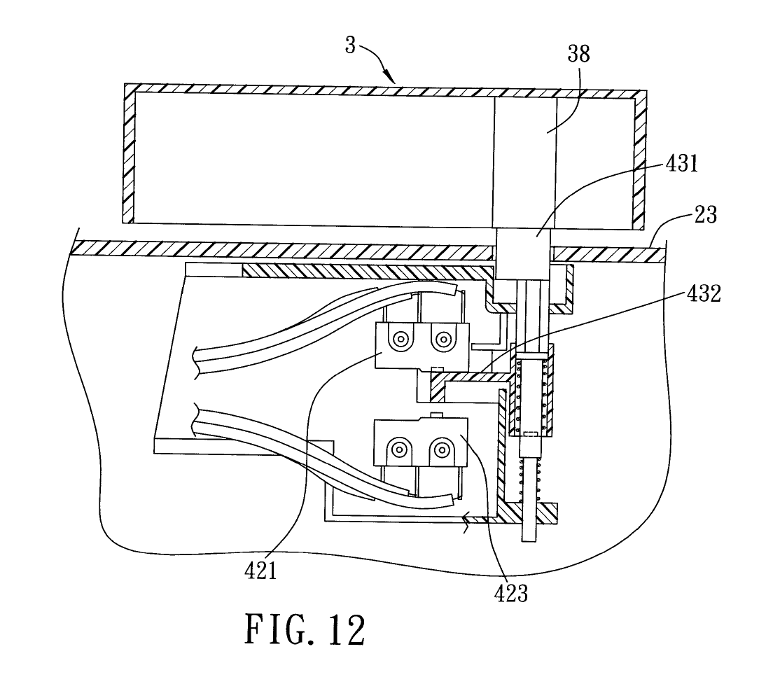

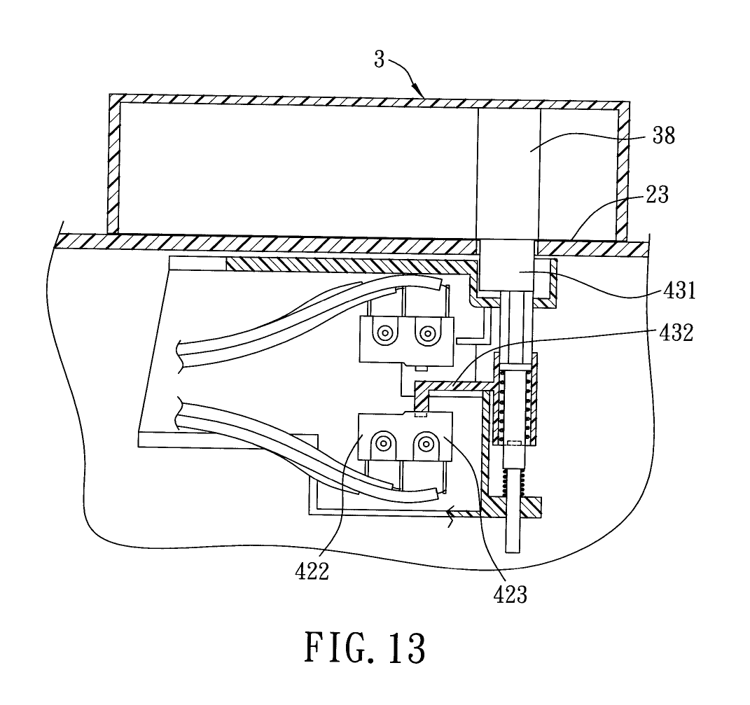

With particular reference to Figs . 4 and 11, the cooking utensil further includes a safety device 4 for controlling supply of power of an external power source (not shown) to the driving motor and the electric heating disk 12 (see FIG. 2). The safety device 4 includes a U-shaped mounting plate 41 disposed fixedly in the second sidewall 23 and having two vertical side plate portions 411 and a horizontal bottom plate portion 412, a switch member 42 fixed on the bottom plate portion 412 and disposed between the side plate portions 411 for controlling power output of the driving support unit 1, a vertical movable rod 43 driven by the lid unit 3 and movable vertically on one of the side plate portions 411 between an upper limit position shown in FIG. 12 and a lower limit position shown in FIG. 13 for controlling operation of the switch member 42, and a second spring unit configured as a coiled compression spring 44 sleeved on the movable rod 43 for biasing the movable rod 43 toward the upper limit position.

The switch member 42 has first, second, and third contact portions 421, 422, 423 fixed on the mounting plate 41. The second contact portion 422 is disposed below and spaced apart from the first contact portion 421. The third contact portion 423 is aligned horizontally with and in contact with the second contact portion 422. The movable rod 43 has a pushbutton portion 431 driven by the pressing block 38 and retractable downwardly into and extendable upwardly from the second sidewall 23, and a laterally extending contact portion 432 disposed between the first contact portion 421 and an assembly of the second and third contact portions 422, 423.

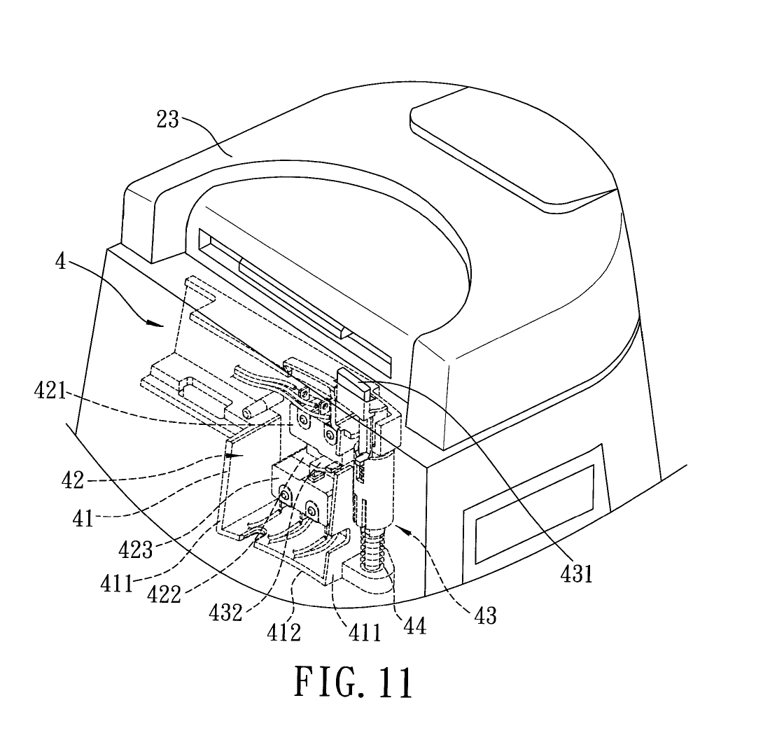

With particular reference to FIGS. 11 and 12, when the lid unit 3 is not fully closed, the pressing block 38 is spaced apart from the pushbutton portion 431 so that the pushbutton portion 431 extends outwardly from the second sidewall 23. In this situation, the laterally extending contact portion 432 is in contact with the first contact portion 421, so that the external power source cannot supply a power to the driving motor, the circuit board, and the electric heating disk 12 (see FIG. 2), thereby preventing operation of the shredding cutter 14 (see FIG. 2) and the electric heating disk 12. Also in this situation, the third contact portion 423 generates a signal so that the time indicator 24 (see FIG. 1) is activated to show a digital code (e.g., 1102) representing that the lid unit 3 is opened, and so that the time-controlling rotary knob 25 (see FIG. 1), the speed-controlling rotary knob 26 (see FIG. 1), and the rotation-controlling pushbutton 27 cannot perform their functions. In other words, the switch member 42 can control the driving support unit 2 to stop output of the power.

With particular reference to FIGS. 11 and 13, when the lid unit 3 is fully closed, the pushbutton portion 431 is pressed downwardly by the pressing block 38 to retract into the second sidewall 23. In this situation, the laterally extending contact portion 432 is in contact with the second and third contact portions 422, 423, so that the external power supply supplies the power to the driving motor to thereby activate the shredding cutter 14 and the electric heating disk 12 and so that the time-controlling rotary knob 25 (see FIG. 1), the speed-controlling rotary knob 26 (see FIG. 1), and the rotation-controlling pushbutton 27 can perform their functions. In other words, the switch member 42 can control the driving support unit 2 to output the power.

In view of the above, the cooking utensil of this invention has the following advantages:

1. To open the lid unit 3, it is only necessary to depress the controlling member 53. That is, the hand of the user does not need to touch the top lid 31 to avoid damage caused to the hand due to contact with the top lid 31 or steam escaped from the bowl body 11.
2. The lid unit 3 can be removed from the cooking bowl unit 1 by simply pushing and removing the retaining tongue 37 from the retaining ring 28 for cleaning. After a cleaning process is finished, the lid unit 3 can be inserted into the recess 221 in the first sidewall 22 to allow the retaining tongue 37 to engage automatically the retaining ring 28, thereby retaining the lid unit 3 on the cooking blow unit 1.
3. When the retaining block 36 is retained on the second sidewall 23 by the locking member 51, as shown in FIG. 9, the lid unit 3 can be locked firmly at a fully closed position.
4. When the lid unit 3 is disposed at a position other than the fully closed position, the safety device 7 is activated to stop supply of power from the external power source to the shredding cutter 14 and the electric heating disk 12, thereby enhancing safety during use. Furthermore, since operation of the safety device 4 is controlled by opening and closing of the lid unit 3, undesired activation and deactivation of the safety device 4 can be avoided effectively.

With this invention thus explained, it is apparent that numerous modifications and variations can be made without departing from the scope and spirit of this invention. It is therefore intended that this invention be limited only as indicated by the appended claims.

I claim:

1. A cooking utensil comprising:
a cooking bowl unit including a bowl body;
a driving support unit outputting a power to said cooking bowl unit and including a bottom seat supporting said cooking bowl unit thereon, and first and second sidewalls disposed respectively on two opposite sides of said bottom seat;
a lid unit including a top lid disposed pivotally on said bowl body for covering a top end opening of said blow body, a pivoting block disposed fixedly on said top lid, a positioning block connected pivotally to said pivoting block and connected removably to said first sidewall, and a retaining block disposed on a periphery of said top lid; and
a lid-opening device disposed on said second sidewall and including a locking member locking said retaining block releaseably on said second sidewall, and a controlling member operable to release said retaining block from said second sidewall.

2. The cooking utensil as claimed in claim 1, wherein said driving support unit further includes a retaining ring disposed fixedly on said first sidewall, said lid unit further including a resilient retaining tongue disposed on said positioning block and engaging said retaining ring so as to retain said lid unit on said first sidewall, said retaining tongue being pushable to pivot on said positioning block to separate from said retaining ring.

3. The cooking utensil as claimed in claim 1, wherein said lid unit further includes a pivot shaft extending through said pivoting block and said positioning block for interconnecting said pivoting block and said positioning block pivotally, and a torsion spring sleeved on said pivot shaft for biasing said top lid to pivot upwardly relative to said bowl body.

4. The cooking utensil as claimed in claim 1, wherein said locking member is movable horizontally on said second sidewall between a locking position and a release position, said locking member having a retaining end for locking said retaining block releaseably on said second sidewall, and a driven end opposite to said retaining end and contactable with said controlling member.

5. The cooking utensil as claimed in claim 4, wherein said driven end of said locking member has an inclined guiding surface, said controlling member being movable vertically relative to said second sidewall to contact said inclined guiding surface.

6. The cooking utensil as claimed in claim 5, wherein said controlling member is operable to move said locking member to the release position so as to remove said retaining end of said locking member from said retaining block, after which said controlling member can be released to allow said locking member to be biased to the locking position, so that said inclined guiding surface comes into contact with said controlling member.

7. The cooking utensil as claimed in claim 6, wherein said lid-opening device further includes a first spring unit for biasing said locking member toward the locking position.

8. The cooking utensil as claimed in claim 5, wherein said locking member is disposed in said second sidewall, and said controlling member has an actuator portion exposed outwardly of said second sidewall, and a connecting portion connected to said actuator portion and extending into said second sidewall, said connecting portion having an inclined contact surface contactable with said inclined guiding surface of said locking member.

9. The cooking utensil as claimed in claim 1, further comprising a safety device, said safety device including a switch member disposed in said second sidewall for controlling power output of said driving support unit, and a movable rod controlling operation of said switch member and driven by said lid unit to move vertically relative to said second sidewall in such a manner that, when said retaining block is locked on said second sidewall by said locking member, said lid unit presses against said movable rod such that said movable rod is disposed at a lower limit position, so that said switch member controls said driving support unit to output the power, and when said lid unit is removed from said locking member and said movable rod, said movable rod is biased to an upper limit position, so that said switch member controls said driving support unit to stop output of the power.

10. The cooking utensil as claimed in claim 9, wherein said safety device further includes a U-shaped mounting plate disposed fixedly in said second sidewall and having two vertical side plate portions and a horizontal bottom plate portion, said switch member being fixed on said bottom plate portion and disposed between said side plate portions, said movable rod being disposed on one of said side plate portions.

11. The cooking utensil as claimed in claim 9, wherein said safety device further includes a second spring unit sleeved on said movable rod for biasing said movable rod toward the upper limit position.

12. The cooking utensil as claimed in claim 9, wherein said movable rod has a pushbutton portion retractable downwardly into and extendable upwardly from said second sidewall, said lid unit further includes a pressing block disposed on said retaining block and adjacent to said periphery of said top lid such that, when said retaining block is locked on said second sidewall by said locking member, said pressing block presses said pushbutton portion downwardly into said second sidewall, and when said retaining block is removed from said locking member, said pressing member is removed from said pushbutton portion, and said pushbutton portion extends upwardly from said second sidewall.

13. The cooking utensil as claimed in claim 1, wherein said switch member has a first contact portion and a second contact portion disposed below and spaced apart from said first contact portion, said movable rod having a laterally extending contact portion that is positioned such that, said laterally extending contact portion is movable upwardly relative to said second sidewall to contact said first contact portion, and is movable downwardly relative to said second sidewall to contact said second contact portion.

14. The cooking utensil as claimed in claim 13, wherein said switch member further has a third contact portion aligned horizontally with said second contact portion, said laterally extending contact portion being movable downwardly relative to said second sidewall to contact said second and third contact portions simultaneously.

15. The cooking utensil as claimed in claim 1, wherein said cooking bowl unit further includes an electric heating disk disposed in a bottom end of said bowl body and cooperating with an inner wall surface of said bowl body to define a food receiving space, and a shredding cutter disposed rotatably within a bottom end of said food receiving space, said driving support unit outputting the power to activate said electric heating disk and said shredding cutter.

16. The cooking utensil as claimed in claim 15, wherein said electric heating disk has at least one driver-connecting terminal extending into and electrically connected to said driving support unit, said shredding cutter having a rotating shaft extending downwardly from said bottom
